(19) United States
(12) Patent Application Publication
(10) Pub. No.: US 2024/0362776 A1
(43) Pub. Date: Oct. 31, 2024

(54) RADIOGRAPHIC IMAGE ANALYSIS APPARATUS AND RECORDING MEDIUM

(71) Applicant: Konica Minolta, Inc., Tokyo (JP)

(72) Inventors: Akinori TSUNOMORI, Tokyo (JP); Satoshi NOMA, Tenri-shi (JP); Masakuni UEYAMA, Tenri-shi (JP)

(21) Appl. No.: 18/643,466

(22) Filed: Apr. 23, 2024

(30) Foreign Application Priority Data
Apr. 27, 2023 (JP) 2023-072945

(51) Int. Cl. G06T 7/00; G06T 7/11

(52) U.S. Cl. CPC G06T 7/0012; G06T 7/11; G06T 2207/10124; G06T 2207/30061

(57) ABSTRACT

A radiographic image analysis apparatus includes a hardware processor. The hardware processor estimates a respiratory function of a subject based on a feature amount of a region of interest extracted from a dynamic image of a chest of the subject and examination result information on a past respiratory function examination on the subject.

### BACKGROUND OF THE INVENTION

### Technical Field

The present invention relates to a radiographic image analysis apparatus and a recording medium.

### Description of Related Art

Conventionally, spirometry has been used as a method for measuring a respiratory function. However, spirometry imposes a large burden on a patient. In particular, if spirometry is performed multiple times to observe the respiratory function for a while, the burden on a patient becomes larger. Further, if the condition of the patient becomes worse during the observation, it is difficult to perform a respiratory function examination by spirometry.

As an alternative to spirometry, a method of estimating the respiratory function from a dynamic image acquired by dynamic imaging of a chest has been studied (see, for example, Japanese Unexamined Patent Publication No. 2019-187862). Dynamic imaging is less invasive than spirometry and imposes less burden on a patient.

### SUMMARY OF THE INVENTION

However, for follow-up (observation), for example, in order to grasp change in the respiratory function between before and after a surgery or the like, it is necessary to more accurately estimate the respiratory function. Further, in order to replace examinations with spirometry by examinations with dynamic imaging, it is necessary, from the viewpoint of reliability of examinations, to increase the estimation accuracy.

Objects of the present invention include improving the estimation accuracy in estimating the respiratory function from a dynamic image acquired by dynamic imaging.

To achieve at least one of the abovementioned objects. according to an aspect of the present invention. a radiographic image analysis apparatus reflecting one aspect of the present invention includes a hardware processor that estimates a respiratory function of a subject based on a feature amount of a region of interest extracted from a dynamic image of a chest of the subject and examination result information on a past respiratory function examination on the subject.

According to an aspect of the present invention, a non-transitory computer-readable recording medium reflecting one aspect of the present invention stores a program that causes a computer to estimate a respiratory function of a subject based on a feature amount of a region of interest extracted from a dynamic image of a chest of the subject and examination result information on a past respiratory function examination of the subject.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a view illustrating a whole configuration of a radiographic image analysis system according to an embodiment of the present invention;

FIG. 2 is a flowchart illustrating an imaging control process executed by a controller of an imaging console of FIG. 1;

FIG. 3 is a flowchart illustrating a respiratory function estimation process executed by a controller of an analysis apparatus of FIG. 1; and

FIG. 4 is a graph illustrating a relationship between an estimated FVC and a measured FVC.

### DETAILED DESCRIPTION

Hereinafter, one or more embodiments of the present invention will be described in detail with reference to the drawings. However, the scope of the invention is not limited to the disclosed embodiments or the illustrated examples.

### Configuration of Radiographic Image Analysis System 100

First, a configuration of an embodiment of the present invention will be described.

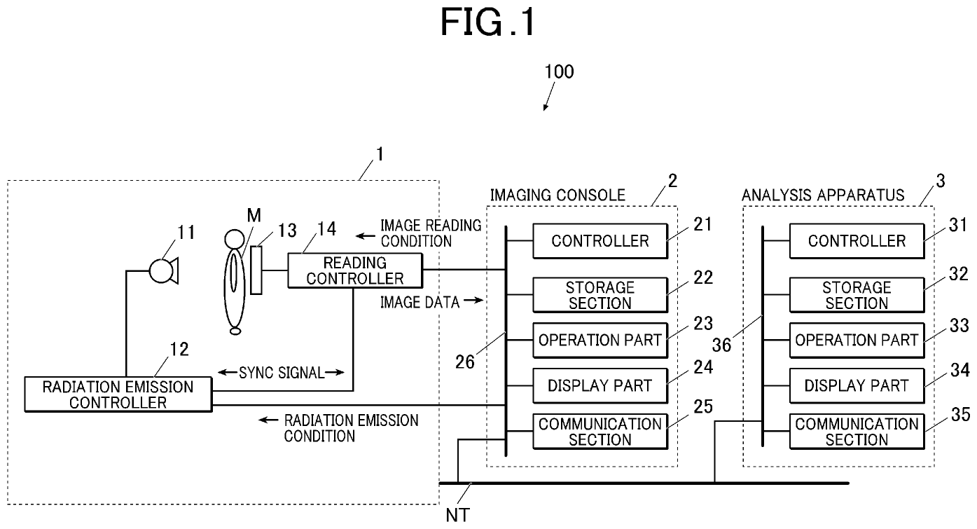

FIG. 1 illustrates an example of the overall configuration of a radiographic image analysis system 100 according to the present embodiment.

As illustrated in FIG. 1, the radiographic image analysis system 100 includes an imaging apparatus 1, an imaging console 2, and an analysis apparatus 3 (radiographic image analysis apparatus). The imaging apparatus 1 and the imaging console 2 are connected to each other by a communication cable or the like. The imaging console 2 and the analysis apparatus 3 are connected to each other via a communication network NT such as a local area network (LAN). A radiology information system (RIS), a hospital information system (HIS), an electronic medical record system, a picture archiving and communication system (PACS), and the like (all not illustrated) may be connected to the communication network NT. The apparatuses constituting the radiographic image analysis system 100 comply with Digital Image and Communications in Medicine (DICOM) standard. Communication between the apparatuses is performed in accordance with DICOM.

### Configuration of Imaging Apparatus

The imaging apparatus 1 is an imaging means for imaging a dynamic state of the chest having a periodicity (cycle) such as, for example, a morphological change of expansion and contraction of the lungs due to respiratory motion and pulsation of the heart. The dynamic imaging refers to acquiring a plurality of images indicating a dynamic state of a subject by repeatedly irradiating the subject with pulsed radiation such as X-rays at predetermined time intervals (pulse emission) or continuously irradiating the subject with radiation at a low dose rate (continuous emission). A series of images obtained by dynamic imaging is referred to as a dynamic image. Each of the plurality of images constituting the dynamic image is referred to as a frame image. Here, the dynamic imaging includes moving image capturing, but does not include capturing a still image while displaying a moving image. The dynamic image includes a moving image, but does not include an image obtained by capturing a still image while displaying a moving image.

Note that in the following embodiment, a case where dynamic imaging is performed by pulse emission will be described as an example.

The radiation source 11 is disposed at a position facing the radiation detection section 13 with the subject M (an imaging part of the subject) interposed therebetween. The radiation source 11 irradiates the subject M with radiation (X-rays) under the control of the radiation emission controller 12.

The radiation emission controller 12 is connected to the imaging console 2. The radiation emission controller 12 performs radiographic imaging by controlling the radiation source 11 based on radiation emission conditions input from the imaging console 2. The radiation emission conditions input from the imaging console 2 include, for example, a pulse rate, a pulse width, a pulse interval, the number of imaging frames per imaging, a value of an X-ray tube current, a value of an X-ray tube voltage, and a type of additional filter. The pulse rate is the number of times of radiation emission per second, and matches a frame rate to be described later. The pulse width is a radiation emission time per radiation emission. The pulse interval is a time from the start of one radiation emission to the start of the next radiation emission, and matches a frame interval to be described later.

The radiation detection section 13 is constituted by a semiconductor image sensor such as an FPD. The FPD includes, for example, a glass substrate or the like. At predetermined positions on the glass substrate, a plurality of detection elements (pixels) are arranged in a matrix. Each pixel detects radiation emitted from the radiation source 11 and transmitted through at least the subject M in accordance with the intensity of the radiation, converts the detected radiation into an electric signal, and accumulates the electric signal. Each pixel includes a switching section such as a thin film transistor (TFT). Note that FPDs include an indirect conversion type in which X-rays are converted into electrical signals by photoelectric conversion elements via a scintillator and a direct conversion type in which X-rays are directly converted into electrical signals, and either of these may be used.

The radiation detection section 13 is provided so as to face the radiation source 11 with the subject M interposed therebetween.

The reading controller 14 is connected to the imaging console 2. The reading controller 14 controls the switching section of each pixel of the radiation detection section 13 on the basis of image reading conditions input from the imaging console 2 to switch the electrical signals accumulated in the pixels to read, and reads the electrical signals accumulated in the radiation detection section 13. Accordingly, the reading controller 14 acquires the image data. This image data is a frame image(s). Then, the reading controller 14 outputs the acquired frame image to the imaging console 2. The image reading conditions are, for example, a frame rate, a frame interval, a pixel size, an image size (matrix size), and the like. The frame rate is the number of frame images acquired per second, and matches the pulse rate. The frame interval is the time from the start of the operation of acquiring one frame image to the start of the operation of acquiring the next frame image, and matches the pulse interval.

Here, the radiation emission controller 12 and the reading controller 14 are connected to each other and exchange sync signals with each other to synchronize the radiation emission operation and the image reading operation.

### Configuration of Imaging Console 2

The imaging console 2 outputs the radiation emission conditions and the image reading conditions to the imaging apparatus 1 to control radiographic imaging and radiographic image reading of the imaging apparatus 1. Further, the imaging console 2 displays the dynamic image acquired by the imaging apparatus 1 for confirmation of positioning and confirmation of whether or not the image is suitable for diagnosis by a radiographer such as a radiologist.

As shown in FIG. 1, the imaging console 2 includes a controller 21, a storage section 22, an operation part 23, a display part 24, and a communication section 25.communication part These components of the imaging console 2 are connected to each other by a bus 26.

The controller 21 includes a central processing unit (CPU), a random access memory (RAM), and the like. The CPU of the controller 21 reads a system program and various process programs stored in the storage section 22 in response to operations with the operation part 23, loads the programs in the RAM, and executes various processes including an imaging control process to be described later in accordance with the programs. Thus, the controller 21 centrally controls the operation of each component of the imaging console 2 and the radiation emission operation and the reading operation of the imaging apparatus 1.

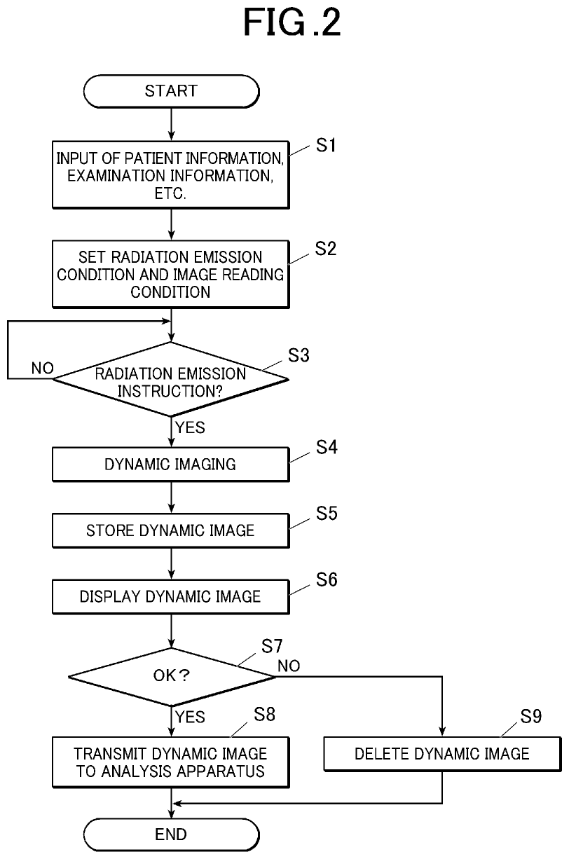

The storage section 22 includes a nonvolatile semiconductor memory, a hard disk and/or the like. The storage section 22 stores various programs executed by the controller 21, parameters necessary for execution of processes of the programs, and/or data such as process results. For example, the storage section 22 stores a program for executing the imaging control process illustrated in FIG. 2. Further, the storage section 22 stores the radiation emission conditions and the image reading conditions for imaging parts and an imaging directions. The various programs are stored in the storage section 22 in the form of readable program codes. The controller 21 sequentially executes operations (actions) in accordance with the program codes.

The operation part 23 includes a keyboard including cursor keys, number input keys, various function keys, and the like, and a pointing device such as a mouse. The operation part 23 outputs, to the controller 21, an instruction signal input by a key operation on the keyboard or an operation with the mouse. The operation part 23 may include a touch screen provided on the display screen of the display part 24. In this case, the operation part 23 outputs an instruction signal input via the touch screen to the controller 21.

The display part 24 includes a monitor such as a liquid crystal display (LCD) or a cathode ray tube (CRT). The display part 24 displays input instructions from the operation part 23, data, and the like in accordance with instructions of display signals input from the controller 21.

The communication section 25 includes a LAN adapter, a modem, and a terminal adapter (TA). The communication section 25 controls data transmission and reception between the imaging console 2 and each apparatus connected to the communication network NT.

### Configuration of Analysis Apparatus 3

The analysis apparatus 3 acquires the dynamic image from the imaging console 2, analyzes the acquired dynamic image, and displays the analysis result. In the present embodiment, the analysis apparatus 3 estimates the respiratory function (an index value indicating the respiratory function) on the basis of a dynamic image of the chest.

As shown in FIG. 1, the analysis apparatus 3 includes a controller 31 (hardware processor), a storage section 32, an operation part 33, a display part 34, and a communication section 35, and these components are connected by a bus 36.

The controller 31 includes a CPU, a RAM, and the like. The CPU of the controller 31 reads a system program and various process programs stored in the storage section 32 in response to operations with the operation part 33, loads the programs in the RAM, and centrally controls the operation of each component of the analysis apparatus 3 in accordance with the programs. The CPU of the controller 31 executes various processes including a respiratory function estimation process to be described later in cooperation with a program stored in the storage section 32. The controller 31 functions as an estimation means.

The storage section 32 includes a nonvolatile semiconductor memory, a hard disk and/or the like. The storage section 32 stores various programs, parameters necessary for execution of processes of the programs, and/or data such as process results. The programs stored in the storage section 32 include a program for the controller 31 to perform the respiratory function estimation process. These various programs are stored in the storage section 32 in the form of readable program codes. The controller 31 sequentially executes operations (actions) in accordance with the program codes.

The storage section 32 also stores the dynamic image received from the imaging console 2 in association with its supplementary information and the estimation result of the respiratory function.

Furthermore, the storage section 32 stores a regression formula (multiple regression formula model) used for estimating the respiratory function in the respiratory function estimation process.

The operation part 33 includes a keyboard including cursor keys, number input keys, various function keys, and the like, and a pointing device such as a mouse. The operation part 33 outputs, to the controller 31, an instruction signal input by a key operation on the keyboard or an operation with the mouse. The operation part 33 may include a touch screen provided on the display screen of the display part 34. In this case, the operation part 33 outputs an instruction signal input via the touch screen to the controller 31.

The display part 34 includes a monitor such as an LCD or a CRT. The display part 34 performs various types of display in accordance with instructions of display signals input from the controller 31.

The communication section 35 includes a LAN adapter, a modem, and a TA. The communication section 35 controls transmission and reception of data between the analysis apparatus 3 and each apparatus connected to the communication network NT.

### Operation of Radiographic Image Analysis System 100

Next, the operation of the radiographic image analysis system 100 will be described.

### Operation of Imaging Apparatus 1 and Imaging Console 2

First, imaging operation performed by the imaging apparatus 1 and the imaging console 2 will be described. FIG. 2 illustrates the imaging control process executed by the controller 21 of the imaging console 2. The 10 imaging control process is executed by the controller 21 in cooperation with the program stored in the storage section 22.

First, the controller 21 receives input of patient information and examination information by a radiographer operating the operation part 23 (Step S1).

The patient information is information on a subject. The patient information includes information such as a patient ID, name, age, gender, height, weight, and the like. The examination information includes an examination ID, an examination date, an imaging part, an imaging direction, and the like. In the present embodiment, the imaging part is the chest, and the imaging direction is the front.

Note that the patient information and the examination information may be acquired from an RIS or an HIS (both not illustrated) via the communication section 25.

Next, based on the input patient information and examination information, the controller 21 reads the radiation emission conditions from the storage section 22 and sets the conditions in the radiation emission controller 12. In addition, the controller 21 reads the image reading conditions from the storage section 22 and sets the conditions in the reading controller 14 (Step S2).

Next, the controller 21 waits for an instruction to emit radiation (Step S3). Here, the radiographer performs positioning by arranging the subject M between the radiation source 11 and the radiation detection section 13, and inputs a radiation emission instruction by operating the operation part 23 at the time when preparations for imaging are completed.

When the radiation emission instruction is input through the operation part 23 (Step S3; YES), the controller 21 outputs an imaging start instruction to the radiation emission controller 12 and the reading controller 14 to start 30 dynamic imaging (Step S4). That is, the controller 21 causes the radiation source 11 to emit radiation at pulse intervals set in the radiation emission controller 12, and causes the radiation detection section 13 to acquire frame images. During the dynamic imaging, the radiographer performs breathing guidance such as “breathe in” and “breathe out” to promote deep breathing. Note that the imaging apparatus 1 may output sound or display of the breathing guidance such as “breathe in” and “breathe out”.

When a radiation emission end instruction is input through the operation part 23, the controller 21 outputs an imaging end instruction to the radiation emission controller 12 and the reading controller 14 to stop the imaging.

The frame images of the dynamic image acquired by the imaging are sequentially input to the imaging console 2. The controller 21 stores the input frame images in the storage section 22 in association with numbers (frame numbers) indicating the order of the imaging (Step S5). Further, the controller 21 causes the display part 24 to display the input frame image(s) (Step S6).

The radiographer checks the positioning and the like with the displayed dynamic image, and determines whether an image suitable for diagnosis has been acquired by the imaging (imaging OK) or re-imaging is necessary (imaging NG). Then, the radiographer operates the operation part 23 to input the determination result.

When the determination result indicating imaging OK is input by a predetermined operation with the operation part 23 (Step S7; YES), the controller 21 attaches, to each of the series of frame images acquired by the dynamic imaging, an identification ID for identifying the dynamic image, the patient information, the examination information, the radiation emission conditions, the image reading conditions, the numbers (frame numbers) indicating the order of the imaging, and the like as supplementary information. The controller 21 transmits the series of frame images with the supplementary information to the analysis apparatus 3 via the communication section 25 (Step S8). Then, the controller 21 ends the imaging control process.

On the other hand, when the determination result indicating imaging NG is input by a predetermined operation with the operation part 23 (Step S7; NO), the controller 21 deletes the series of frame images stored in the storage section 22 (Step S9). Then, the controller 21 ends the imaging control process. In this case, re-imaging is required.

### Operation of Analysis Apparatus 3

Next, operation of the analysis apparatus 3 will be described.

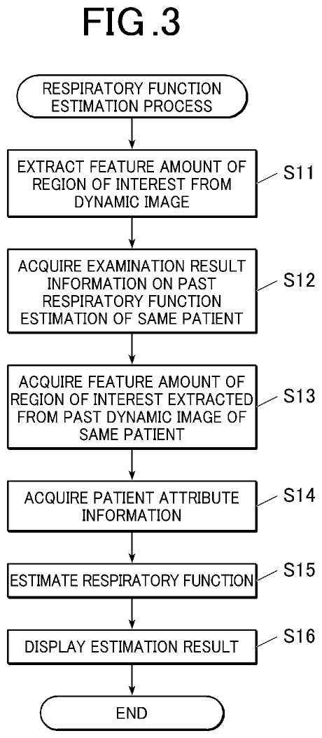

In the analysis apparatus 3, when a dynamic image is received, for example, from the imaging console 2 via the communication section 35, the controller 31 causes the storage section 32 to store the received dynamic image in association with the supplementary information. When estimation of the respiratory function for the dynamic image of the chest stored in the storage section 32 is instructed by an operation with the operation part 33, the controller 31 executes the respiratory function estimation process. The respiratory function estimation process is executed by the controller 31 in cooperation with the program stored in the storage section 32. Hereinafter, the respiratory function estimation process will be described with reference to FIG. 3.

In the respiratory function estimation process, first, the controller 31 extracts a feature amount of a region of interest from the dynamic image as a respiratory function estimation target (Step S11).

Here, the region of interest is a region of a specific structure. The specific structure is a structure that moves with respiratory motion, that is, a structure whose size, position, density, and/or the like change with respiratory motion. In the present embodiment, the region of interest is a lung field region(s). In addition, the feature amount of the region of interest is a value that changes with respiration in the specific structure. In the present embodiment, the feature amount of the region of interest includes the maximum lung field area (the lung field area at the maximum inhalation level) and the minimum lung field area (the lung field area at the maximum exhalation level) in breathing.

In Step S11, the controller 31 first recognizes the lung field region from each frame image of the dynamic image. As a method of recognizing the lung field region, known image processing such as edge detection may be used, or machine learning or the like may be used for the recognition. Next, the controller 31 counts the number of pixels in the recognized lung field region, and extracts (calculates) the area of the lung field region in each frame image based on the counted number of pixels. For example, the controller 31 multiplies the number of pixels in each of the right and left lung field regions by the pixel size to calculate the area of each of the right and left lung field regions, and calculates the area obtained by adding the areas of the right and left lung field regions as the area of the lung field region. Then, the controller 31 acquires the maximum lung field area and the minimum lung field area among the calculated areas of the lung field region, as the feature amount of the region of interest.

Next, the controller 31 acquires examination result information on a past respiratory function examination(s) of the same patient (same subject) (Step S12).

For example, the controller 31 causes the display part 34 to display an input screen for the examination result information on the past respiratory function examination of the same patient, and acquires the examination result information on the past respiratory function examination of the same patient in response to an input operation on the input screen with the operation part 33. Alternatively, the controller 31 may request a terminal apparatus or a system (for example, a terminal apparatus at a respiratory function examination room or an electronic medical record system) storing examination result information on respiratory function examinations to transmit the examination result information on the past respiratory function examination of the same patient (having the same patient ID) via the communication section 35. Then, the controller 31 may obtain the examination result information on the past respiratory function examination of the same patient from the terminal apparatus or system.

In the present embodiment, the controller 31 acquires examination result information on FVC (forced vital capacity) and FEV1.0 (amount per second) as the examination result information on the respiratory function examination. In many cases, the respiratory function examination such as spirometry and dynamic imaging are performed at the patient's (subject's) first visit, and thus the controller 31 can acquire the examination result information on the respiratory function examination at the patient's first visit as the examination result information on the past respiratory function examination. In addition, in a case where a plurality of respiratory function examinations has been performed in the past, the controller 31 preferably acquires the examination result information on the latest respiratory function examination. This is because the respiratory state in the latest respiratory function examination is considered to be closest to the current respiratory state of the patient.

Next, the controller 31 acquires the feature amount of the region of interest extracted from a past dynamic image of the chest of the same patient (Step S13).

In Step S13, the controller 31 retrieves and acquires, from the storage section 32, a dynamic image captured around the same time (substantially the/a same time) as the past respiratory function examination whose examination result information has been acquired in Step S12. Generally, the respiratory function examination and the examination by dynamic imaging are performed on the same day. Therefore, the controller 31 acquires, from the storage section 32, a dynamic image captured on the same day as the past respiratory function examination whose examination result information has been acquired in Step S12. Alternatively, the controller 31 may acquire, from a PACS (not illustrated), a dynamic image captured on the same day as the past respiratory function examination whose examination result information has been acquired in Step S12. Then, the controller 31 extracts the feature amount of the region of interest from the acquired dynamic image.

Note that the controller 31 may store information on the feature amount extracted from the dynamic image in the storage section 32 in association with the dynamic image. Next, if the information on the feature amount of the region of interest is associated with the dynamic image captured around the same time as the past respiratory function examination whose examination result information has been acquired in Step S12, the controller 31 may read and acquire the information on the feature amount from the storage section 32.

Next, the controller 31 acquires patient attribute information (Step S14).

For example, the controller 31 accesses an electronic medical record system or the like (not illustrated) through the communication section 35 and acquires patient attribute information. Examples of the patient attribute information include gender, age, and body mass index (BMI).

Next, the controller 31 estimates the respiratory function of the patient based on the information acquired in Steps S11 to S14 (Step S15).

For example, the controller 31 estimates the FVC as the respiratory function. If the patient is male, the controller 31 estimates the FVC by the following formula (1). If the patient is female, the controller 31 estimates the FVC by the following formula (2). The estimated FVC is referred to as FVCest.

$$[ Math . 1 ]$$

$$FVCest = 4.023 \times 1 {0}^{- 2} + 2.911 \times 1 {0}^{- 5} \times Sins - 2.751 \times 1 {0}^{- 5} \times Sins . clb + 6.366 \times 1 {0}^{- 6} \times Sexp + 2.202 \times 106 \times Sexp . clb + 4.936 \times 1 {0}^{- 4} \times BMI - 2.281 \times {10}^{- 3} \times Age + 1.011 \times FVC . clb - 0.1115 \times FEV 1. . clb \qquad Formula ( 1 )$$

$$[ Math . 2 ]$$

$$FVCest = 2. 123 \times 1 {0}^{- 2} + 2.9 11 \times 1 {0}^{- 5} \times Sins - 2.751 \times 1 {0}^{- 5} \times Sins . clb + 6.366 \times 1 {0}^{- 6} \times Sexp + 2.202 \times {10}^{- 6} \times Sexp . clb + 4.936 \times 1 {0}^{- 4} \times BMI - 2.281 \times 1 {0}^{- 3} \times Age + 1.011 \times FVC . clb - 0.1115 \times FEV 1. . clb \qquad Formula ( 2 )$$

Sins represents the maximum lung field area. Sexp represents the minimum lung field area. Age indicates age. Parameters to which an identifier “.clb” is attached (Sins.clb, Sexp.clb, FVC.clb, and FEV1.0.clb) indicate feature amounts extracted from past examination result information or a dynamic image(s) acquired by past imaging. Parameters to which the identifier “.clb” is not attached (Sins, Sexp) indicate feature amounts extracted from a dynamic image acquired by the current imaging.

That is, if the patient is a male, the controller 31 applies the maximum lung field area extracted from the current dynamic image to Sins in the formula (1). In addition, the controller 31 applies the maximum lung field area extracted from the past dynamic image to Sins.clb in the formula (1). In addition, the controller 31 applies the minimum lung field area extracted from the current dynamic image to Sexp in the formula (1). In addition, the controller 31 applies the minimum lung field area extracted from the past dynamic image to Sexp.clb in the formula (1). In addition, the controller 31 applies the BMI of the patient to BMI in the formula (1). In addition, the controller 31 applies the age of the patient to Age in the formula (1). In addition, the controller 31 applies the value of the FVC in the past respiratory function examination to FVC.clb in the formula (1). In addition, the controller 31 applies the FEV1.0 in the past respiratory function examination to FEV1.0.clb in the formula (1). Thus, the controller 31 calculates the FVCest (estimated value of the FVC). If the patient is a female, the controller 31 applies the maximum lung field area extracted from the current dynamic image to Sins in the formula (2). In addition, the controller 31 applies the maximum lung field area extracted from the past dynamic image to Sins.clb in the formula (2). In addition, the controller 31 applies the minimum lung field area extracted from the current dynamic image to Sexp in the formula (2). In addition, the controller 31 applies the minimum lung field area extracted from the past dynamic image to Sexp.clb in the formula (2). In addition, the controller 31 applies the BMI of the patient to BMI in the formula (2). In addition, the controller 31 applies the age of the patient to Age in the formula (2). In addition, the controller 31 applies the value of the FVC in the past respiratory function examination to FVC.clb in the formula (2). In addition, the controller 31 applies FEV1.0 in the past respiratory function examination to FEV1.0.clb in the formula (2). Thus, the controller 31 calculates the FVCest (estimated value of the FVC).

The above formula (1) and formula (2) are each a regression formula (multiple regression model) generated by multiple regression analysis with the FVC as an objective variable and the parameters of Sins, Sins.clb, Sexp, Sexp.clb, BMI, Age, FVC.clb and FEV1.0.clb as explanatory variables.

Note that for example, FEV1.0 may be estimated by using a regression formula (multiple regression model) generated by multiple regression analysis with FEV1.0 as an objective variable and the parameters same as those described above (Sins, Sins.clb, Sexp, Sexp.clb, BMI, Age, FVC.clb and FEV1.0.clb) as explanatory variables.

Next, the controller 31 displays the estimated FVC on the display part 34 and stores the estimated FVC in the storage section 32 in association with the dynamic image acquired by the current imaging (Step S16), and ends the respiratory function estimation process.

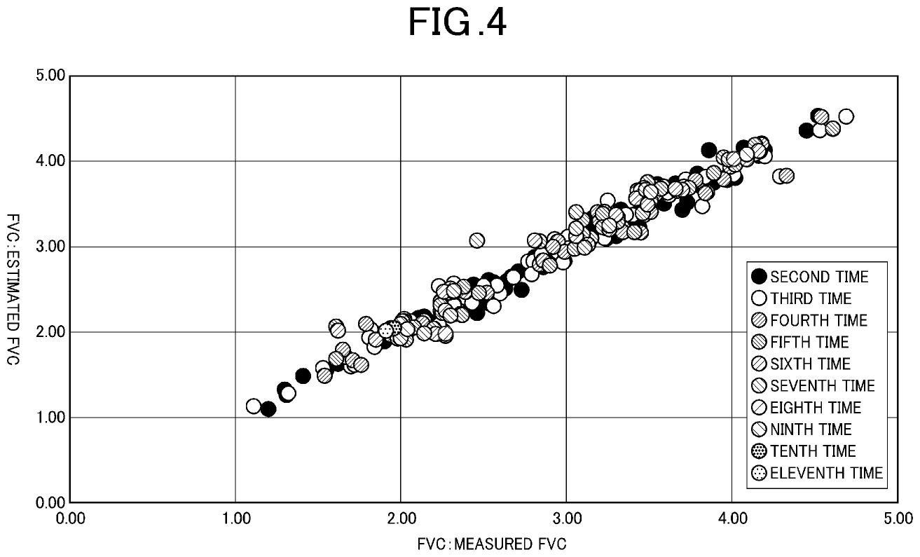

FIG. 4 is a graph illustrating a relationship between the FVCest (estimated FVC) estimated by the above formula (1) or formula (2) and the FVC (measured FVC) measured in the respiratory function examination for the same patient around the same time as the estimation of the FVCest. Of the graph illustrated in FIG. 4, the vertical axis represents the estimated FVC (FVCest), and the horizontal axis represents the measured FCV. As illustrated in FIG. 4, it is found that the estimated FVC very highly correlates with the measured FVC. That is, it is understood that the respiratory function can be estimated with extremely high accuracy based on the feature amount of the region of interest extracted from the dynamic image, the examination result information acquired by the past respiratory function examination for the same patient, the information on the feature amount of the region of interest extracted from the dynamic image obtained by the past dynamic imaging for the same patient, and the patient attribute information.

There has been disclosed that a feature amount of a region of interest linked with respiration, such as lung field areas extracted from a dynamic image, is associated with a respiratory function (for example, refer to Reference 1: N. Ohkura et al., “Chest Dynamic-Ventilatory Digital Radiography in Chronic Obstructive or Restrictive Lung Disease”, International Journal of Chronic Obstructive Pulmonary Disease 2021:16 1393-1399, Reference 2: M. Ueyama et al., “Prediction of forced vital capacity with dynamic chest radiography in interstitial lung disease”, European Journal of Radiology, Jul. 21, 2021, and Japanese Unexamined Patent Publication No. 2019-187862). Then, it has been proposed to estimate a respiratory function on the basis of a feature amount obtained from a dynamic image. However, the respiratory function is greatly different from individual to individual, and if the respiratory function is estimated from only the feature amount of the region of interest of the dynamic image, the individual difference of the respiratory function is not reflected, and thus sufficient estimation accuracy may not be obtained. Then, by adding the past respiratory function examination result of the patient to the parameters used for estimation of the respiratory function, it becomes possible to reflect the individual difference of the respiratory function in the estimation of the respiratory function, and it is considered that the estimation accuracy of the respiratory function can be improved as compared with the conventional technique.

Also, it is considered that the estimation accuracy of the respiratory function can be further improved by adding not only the examination result information on the past respiratory function examination of the patient but also information on the feature amount of the region of interest linked with respiration in the past dynamic image captured around the same time as the past respiratory function examination.

Furthermore, it has already been widely known that age, gender, physique, and the like affect the respiratory function. Therefore, it is considered that the respiratory function can be estimated with higher accuracy by adding these pieces of the patient attribute information to the parameters used for estimation of the respiratory function.

### First Modification Example

In the above-described embodiment, examples of the regression formula used for the estimation of the respiratory function in the case where the feature amount of the region of interest is the maximum lung field area and the minimum lung field area have been described. However, the feature amount of the region of interest is not limited to the maximum lung field area and the minimum lung field area as long as it is a feature amount of a structure that moves with breathing.

For example, the FVCest may be estimated using the regression formula of formula (3) below, where the region of interest is the diaphragm, and the feature amount is the displacement of the diaphragm (Exc) due to respiration.

$$[ Math . 3 ]$$

$$FVCest = a + b \times Exc \_ R + c \times Exc \_ L + d \times Exc \_ R \_ clb + e \times Exc \_ L \_ clb + f \times FVC \_ clb + g + FEV 1. \_clb + h \times BMI + i \times Age \times j \times Gender \qquad Formula ( 3 )$$

In the formula, a to j represent partial regression coefficients (constants). Exc indicates displacement, _R indicates the right lung, _L indicates the left lung. Parameters to which the identifier “_clb” is attached (Exc_R_clb, Exc_L_clb, FVC_clb and FEV1.0_clb) indicate feature amounts acquired from the examination result information on the past respiratory function examination or the past dynamic image. Parameters to which the identifier “_clb” is not attached (Exc_R and Exc_L) indicate feature amounts obtained from the dynamic image acquired by the current imaging. Age indicates age. Gender is a parameter that indicates gender, and is, for example, male: 1 and female: 0. Note that a to h in the formula (3), the formula (4), and the formula (5) are different.

Further, for example, the FVCest may be estimated using the regression formula of formula (4) below, where the region of interest is the trachea, and the feature amount is the amount of change in the tracheal diameter (Tra) due to respiration.

$$[ Math . 4 ]$$

$$FVCest = a + b \times Tra + c \times Tra \_ clb + d \times FVC \_ clb + e \times FEV 1. \_ clb + f \times BMI + g \times Age \times h \times Gender \qquad Formula ( 4 )$$

In the formula, a to h indicate partial regression coefficients (constants). Tra represents the amount of change in the tracheal diameter. Parameters to which the identifier “_clb” is attached (Tra_clb, FVC_clb and FEV1.0_clb) indicate feature amounts acquired from the examination result information on the past respiratory function examination or the past dynamic image. A parameter to which the identifier “_clb” is not attached (Tra) indicates a feature amount obtained from the dynamic image acquired by the current imaging. Age indicates age. Gender is a parameter that indicates gender, and is, for example, male: 1 and female: 0.

Further, for example, the FVCest may be estimated using the regression formula of formula (5) below, where the region of interest is the lung field(s), and the feature amount is the density change rate (De) in the lung field region due to respiration. The density change rate of the lung field region is, for example, an average value of the density change rates of the respective pixel values of the lung field region including the left and right lung field regions.

$$[ Math . 5 ]$$

$$FVCest = a + b \times De + c \times De \_ clb + d \times FVC \_ clb + e \times FEV 1. \_ clb + f \times BMI + g \times Age \times h \times Gender \qquad Formula ( 5 )$$

In the formula, a to h indicate partial regression coefficients (constants). De represents a density change rate (average density change rate) in the lung field region. Parameters to which the identifier “_clb” is attached (De_clb, FVC_clb and FEV1.0_clb) indicate feature amounts acquired from the examination result information on the past respiratory function examination or the past dynamic image. A parameter to which the identifier “_clb” is not attached (De) indicates a feature amount obtained from the dynamic image acquired by the current imaging. Age indicates age. Gender is a parameter that indicates gender, and is, for example, male: 1 and female: 0.

Note that in the above embodiment, the lung field area is the sum of the right and left lung field areas, but the lung field area may be separately calculated for the right and left lungs, and they may be used as parameters of the multiple regression formula. Similarly, in the above modification example, the density change rate is the average value of the density change rates of the pixel values of the lung field regions including the right and left lung field regions, but the density change rate may be separately calculated for the right and left lungs, and they may be used as parameters of the multiple regression formula. Further, for example, FEV1.0 may be estimated using a regression formula generated by multiple regression analysis with FEV1.0 as an objective variable and the parameters used in the formula (3) to the formula (5) as explanatory variables.

### Second Modification Example

In the above-described embodiment, the feature amount(s) of the region of interest extracted from the dynamic image of the chest from the front is the parameter(s) for estimating the respiratory function. Alternatively, the feature amount of the region of interest extracted from the dynamic image of the chest from the side may be used as the parameter for estimating the respiratory function. Further, the feature amounts of the region of interest extracted from both the dynamic images of the chest from the front and the chest from the side may be used as the parameter for estimating the respiratory function.

### Third Modification Example

While the present invention has been described as being applied to the estimation of FVC or FEV1.0 in the above-described embodiment, it may be applied to the prediction of other respiratory functions, such as VC (vital capacity), TLC (total lung capacity), RV (residual volume), and FRC (functional residual capacity), for example.

As described above, the controller 31 of the analysis apparatus 3 estimates the respiratory function of a subject on the basis of a feature amount(s) of a region of interest extracted from a dynamic image of the chest of the subject and examination result information on a past respiratory function examination(s) of the subject.

Therefore, in estimation of the respiratory function from the dynamic image acquired by the dynamic imaging, the estimation accuracy can be improved.

Further, the controller 31 estimates the respiratory function of the subject further on the basis of the feature amount of the region of interest extracted from the dynamic image of the chest of the subject captured around the same time as the respiratory function examination, and hence can further improve the estimation accuracy of the respiratory function.

Further, the controller 31 estimates the respiratory function of the subject further on the basis of the attribute information such as the age, gender, physique and/or the like of the subject, and hence can further improve the estimation accuracy of the respiratory function.

Note that the descriptions in the present embodiment are some preferable examples of the radiographic image analysis apparatus and the program(s) according to the present invention, and the present invention is not limited thereto.

For example, in the above-described embodiment, the case where the function of calculating the feature amount of the region of interest from the dynamic image and the function of estimating the respiratory function using the calculated feature amount are provided in one apparatus has been described as an example. However, the function of calculating the feature amount of the region of interest from the dynamic image may be provided in an apparatus different from the apparatus having the function of estimating the respiratory function.

Furthermore, for example, although in the above, a hard disk, a semiconductor nonvolatile memory, or the like is used as a computer-readable medium storing the program(s) according to the present invention, the computer- readable medium is not limited thereto. As the computer-readable medium, a portable recording medium such as a CD-ROM can be applied. Further, a carrier wave is applied as a medium for providing data of the program(s) according to the present invention via a communication line.

Besides, the detailed configuration and detailed operation of each of the apparatuses constituting the radiographic image analysis system 100 can be appropriately modified without departing from the scope of the present invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-072945, filed on April 27, 2023, including description, claims, drawings and abstract is incorporated herein by reference.

What is claimed is:

1. A radiographic image analysis apparatus comprising a hardware processor that estimates a respiratory function of a subject based on a feature amount of a region of interest extracted from a dynamic image of a chest of the subject and examination result information on a past respiratory function examination on the subject.

2. The radiographic image analysis apparatus according to claim 1, wherein the region of interest is a region of a specific structure that moves with respiration.

3. The radiographic image analysis apparatus according to claim 1, wherein the feature amount of the region of interest is an area of a lung field region, a displacement of a diaphragm, an amount of change in a tracheal diameter, or a density change rate in the lung field region.

4. The radiographic image analysis apparatus according to claim 1, wherein the past respiratory function examination is a respiratory function examination performed at a first visit of the subject or a latest respiratory function examination.

5. The radiographic image analysis apparatus according to claim 1,
wherein the respiratory function examination includes an examination for measuring FVC or FEV1.0, and
wherein the hardware processor estimates the FVC or the FEV1.0 as the respiratory function.

6. The radiographic image analysis apparatus according to claim 1, wherein the hardware processor estimates the respiratory function of the subject further based on a feature amount of the region of interest extracted from a dynamic image of the chest of the subject captured substantially a same time as the respiratory function examination.

7. The radiographic image analysis apparatus according to claim 1, wherein the hardware processor estimates the respiratory function of the subject further based on attribute information on the subject.

8. A non-transitory computer-readable recording medium storing a program that causes a computer to estimate a respiratory function of a subject based on a feature amount of a region of interest extracted from a dynamic image of a chest of the subject and examination result information on a past respiratory function examination of the subject.
